(19) United States
(12) Patent Application Publication
(10) Pub. No.: US 2014/0347618 A1
(43) Pub. Date: Nov. 27, 2014

(54) LIQUID CRYSTAL DEVICE, LIQUID CRYSTAL DEVICE MANUFACTURING METHOD, AND ELECTRONIC APPARATUS

(71) Applicant: Seiko Epson Corporation, Tokyo (JP)

(72) Inventor: Takahiro Shirai, Chino-shi (JP)

(73) Assignee: Seiko Epson Corporation, Tokyo (JP)

(21) Appl. No.: 14/281,080

(22) Filed: May 19, 2014

(30) Foreign Application Priority Data
May 22, 2013 (JP) 2013-107725

(51) Int. Cl. G02F 1/1339

(52) U.S. Cl. CPC G02F 1/1339
USPC 349/153

(57) ABSTRACT

A liquid crystal device includes an element substrate, a first protruding member that is arranged around a display region on the element substrate, a second protruding member that is arranged around the first protruding member, a spacer that is higher than the first protruding member and the second protruding member and is arranged at least between the first protruding member and the second protruding member, a sealing member that is arranged so as to cover the first protruding member, the second protruding member, and the spacer, and a second substrate that is bonded to the first substrate so as to hold a liquid crystal layer with the sealing member between the second substrate and the first substrate.

### BACKGROUND

1. Technical Field

The present invention relates to a liquid crystal device, a liquid crystal device manufacturing method, and an electronic apparatus.

2. Related Art

As the liquid crystal device, for example, known has been a liquid crystal device with an active driving system, which includes a transistor as an element for controlling switching of a pixel electrode for each pixel. The liquid crystal device has been used for light valves of a direct view-type display and a projector, for example.

For example, the liquid crystal device is configured by holding a liquid crystal layer between a pair of substrates (TFT array substrate, counter substrate), and bonding these substrates with a sealing member made of an organic material, as described in JP-A-2008-145934. For example, in JP-A-2008-145934, a projecting portion is provided on the substrate and the sealing member is arranged on the projecting portion.

The existing technology, however, has a problem that water enters the liquid crystal layer through the sealing member made of the organic material and alignment regulating force is weakened, resulting in lowering of display quality.

### SUMMARY

An advantage of some aspects of the invention is to solve at least a part of the issues mentioned above and can be realized in the following modes or application examples.

### Application Example 1

A liquid crystal device according to Application Example 1 includes a first substrate, a first protruding member that is arranged around a display region above a first surface of the first substrate, a second protruding member that is arranged around the first protruding member, a spacer that is arranged between the first protruding member and the second protruding member, and the spacer is higher than the first protruding member and the second protruding member respectively, a sealing member that is arranged so as to cover the first protruding member, the second protruding member, and the spacer, and a second substrate that is bonded to the first substrate so as to hold a liquid crystal layer with the sealing member between the second substrate and the first substrate.

With the configuration of Application Example 1, the first protruding member and the second protruding member that are lower than the spacer are arranged in a region covered by the sealing member. Therefore, the spacer can define a cell gap and a space between the second substrate and each protruding member can be made small. In other words, the thickness of the sealing member on each protruding member can be made small. Thus, each protruding member made of an inorganic material is provided in the sealing member, so that water is difficult to pass through the sealing member from the outside, thereby suppressing permeation of water into the liquid crystal layer. This can suppress lowering of display quality.

### Application Example 2

In the liquid crystal device according to the above application example, it is preferable that a third protruding member that is arranged around the second protruding member, and the third protruding member is lower than the spacer.

With the configuration of Application Example 2, the third protruding member is arranged in addition to the first protruding member and the second protruding member. Therefore, water can be made to be more difficult to pass through the sealing member, thereby suppressing permeation of water into the liquid crystal layer.

### Application Example 3

In the liquid crystal device according to the above application example, it is preferable that at least one of the first protruding member, the second protruding member, and the third protruding member having a substantially triangle shape in a cross sectional view when viewed from a direction parallel to the first surface.

With the configuration of Application Example 3, the cross-sectional shapes are substantially triangle. Therefore, when the spacer is arranged on the formation region of the sealing member, the spacer can be arranged between the protruding member and the protruding member without being placed on the apexes of the substantially triangular shapes.

### Application Example 4

In the liquid crystal device according to the above application example, it is preferable that the spacer is arranged so as to make contact with a surface between the first protruding member and the second protruding member.

With the configuration of Application Example 4, when the spacer is arranged between the first protruding member and the second protruding member, a cell gap can be determined based on the height of the spacer.

### Application Example 5

A liquid crystal device manufacturing method according to Application Example 5 includes forming a first protruding member around a display region on a first substrate, and forming a second protruding member around the first protruding member on the first substrate, arranging a spacer higher than the first protruding member and the second protruding member at least between the first protruding member and the second protruding member, and forming a sealing member so as to cover the first protruding member and the second protruding member, supplying liquid crystal to a region surrounded by the sealing member, and bonding the first substrate and the second substrate with the sealing member.

With the configuration of Application Example 5, the first protruding member and the second protruding member that are lower than the spacer are formed in the region covered by the sealing member. Therefore, the spacer can define the cell gap and a space between the second substrate and each protruding member can be made small. In other words, the thickness of the sealing member on each protruding member can be made small. Thus, each protruding member made of an inorganic material is provided in the sealing member, so that water is difficult to pass through the sealing member from the outside, thereby suppressing permeation of water into the liquid crystal layer. This can suppress lowering of display quality.

### Application Example 6

An electronic apparatus according to Application Example 6 includes the liquid crystal device according to the above-mentioned application example.

With the configuration of Application Example 6, the electronic apparatus includes the above-mentioned liquid crystal device. Therefore, an electronic apparatus that can suppress lowering of display quality can be provided.

### BRIEF DESCRIPTION OF THE DRAWINGS

The invention will be described with reference to the accompanying drawings, wherein like numbers reference like elements.

FIG. 1 is a schematic plan view illustrating the configuration of a liquid crystal device.

FIG. 2 is a schematic cross-sectional view of the liquid crystal device as illustrated in FIG. 1 cut along a line II-II.

FIG. 3 is an equivalent circuit diagram illustrating the electric configuration of the liquid crystal device.

FIG. 4 is a schematic cross-sectional view mainly illustrating the configuration of a pixel of the liquid crystal device.

FIGS. 5A and 5B are schematic views mainly illustrating the configurations of a sealing member and protruding members of the liquid crystal device.

FIG. 6 is a schematic cross-sectional view of the liquid crystal device as illustrated in FIG. 5A cut along a line VI-VI.

FIG. 7 is a flowchart illustrating a liquid crystal device manufacturing method in the order of procedures.

FIGS. 8A to 8C are schematic cross-sectional views illustrating a method of manufacturing the protruding members in the liquid crystal device manufacturing method.

FIG. 9 is a schematic view illustrating the configuration of a projection-type display apparatus including the liquid crystal device.

FIGS. 10A to 10C are schematic cross-sectional views illustrating the configuration of protruding members according to a variation.

### DESCRIPTION OF EXEMPLARY EMBODIMENTS

Hereinafter, embodiments to which the invention is embodied are described with reference to the accompanying drawings. The drawings to be used are illustrated in an enlarged or contracted manner appropriately such that portions to be described are made recognizable.

In the following embodiments, for example, an expression “on a substrate” indicates the case where a constituent component is arranged on the substrate in a contact manner, the case where a constituent component is arranged on the substrate through another constituent component, or the case where a part of a constituent component is arranged on the substrate in a contract manner and another part thereof is arranged through another constituent component.

In the embodiment, a liquid crystal device is described by using an active matrix-type liquid crystal device including thin film transistors (TFTs) as switching elements of pixels as an example. The liquid crystal device can be preferably used as a light modulator (liquid crystal light valve) of a projection-type display apparatus (liquid crystal projector), for example.

### Configuration of Liquid Crystal Device

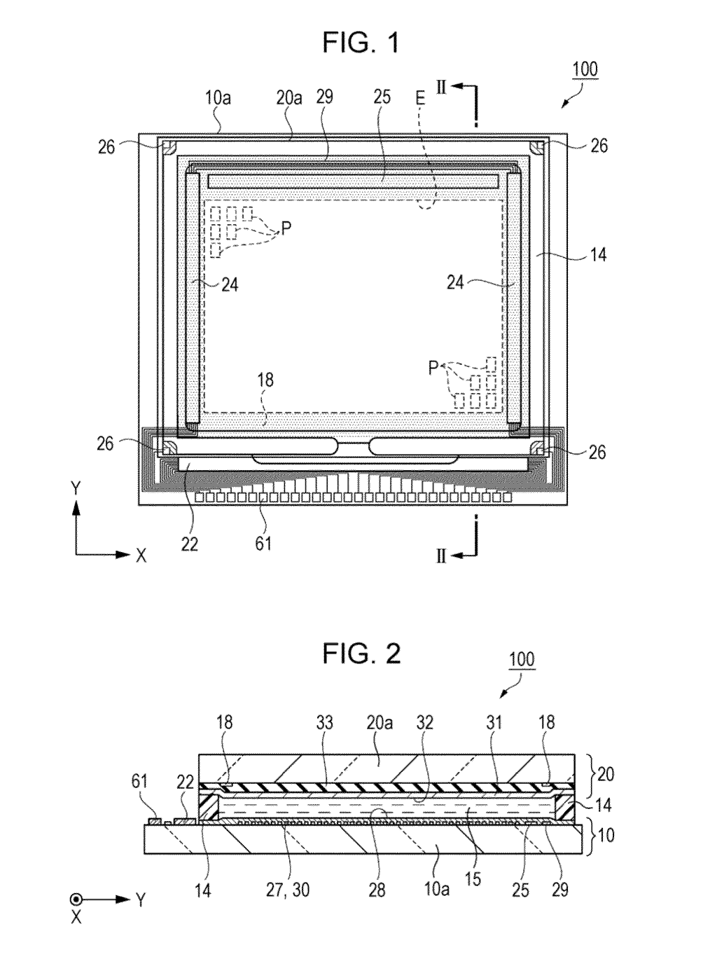

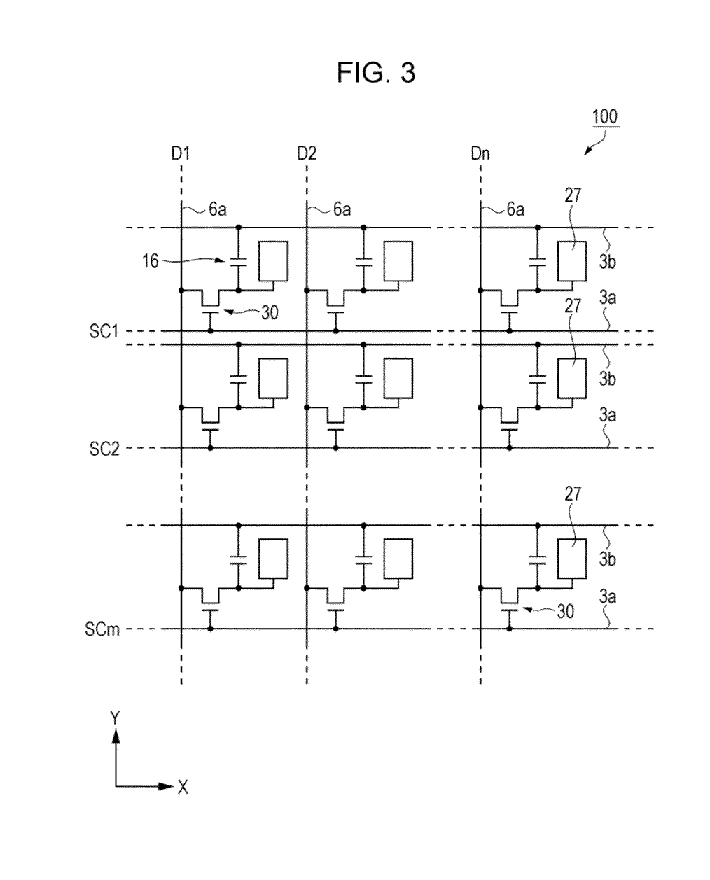

FIG. 1 is a schematic plan view illustrating the configuration of the liquid crystal device. FIG. 2 is a schematic cross-sectional view of the liquid crystal device as illustrated in FIG. 1 cut along a line II-II. FIG. 3 is an equivalent circuit diagram illustrating the electric configuration of the liquid crystal device. Hereinafter, the configuration of the liquid crystal device is described with reference to FIG. 1 to FIG. 3.

As illustrated FIG. 1 and FIG. 2, a liquid crystal device 100 according to the embodiment includes an element substrate 10 (first substrate) and a counter substrate 20 (second substrate) that are arranged so as to oppose each other, and a liquid crystal layer 15 held between the pair of substrates 10 and 20. A transparent substrate such as a glass substrate or a quartz substrate is used as a first base member 10a as a substrate configuring the element substrate 10 and a second base member 20a configuring the counter substrate 20.

The element substrate 10 is larger than the counter substrate 20 and both the substrates 10 and 20 are bonded to each other with a sealing member 14 arranged along the outer circumference of the counter substrate 20. The liquid crystal layer 15 is configured by injecting liquid crystal into between the element substrate 10 and the counter substrate 20 at the inner side of the sealing member 14 provided in a frame form when seen from the above. The liquid crystal has positive or negative dielectric anisotropy. For example, an adhesive such as a thermosetting or ultraviolet-curable epoxy resin is employed as the sealing member 14. A spacer (not illustrated) for keeping a constant space between the pair of substrates is mixed into the sealing member 14.

A display region E on which a plurality of pixels P are aligned is provided at the inner side of the inner edge of the sealing member 14. The display region E may include dummy pixels arranged so as to surround plurality of pixels P in addition to this plurality of pixels P contributing to display. Although not illustrated in FIG. 1 and FIG. 2, a light-shielding film (black matrix: BM) defining the plurality of pixels P two-dimensionally in the display region E is provided on the counter substrate 20.

A data line driving circuit 22 is provided between the sealing member 14 along one side of the element substrate 10 and the one side of the element substrate 10. A test circuit 25 is provided between the sealing member 14 along another side opposing the one side and the display region E. Further, scan line driving circuits 24 are provided between the sealing member 14 along other two sides which are orthogonal to the one side and oppose each other and the display region E. A plurality of wirings 29 connecting the two scan line driving circuits 24 are provided between the sealing member 14 along another side opposing the one side and the test circuit 25.

A light-shielding film 18 (parting portion) is provided between the sealing member 14 arranged in the frame form on the counter substrate 20 and the display region E. The light-shielding film 18 is made of a metal or metal oxide having a light shielding property, for example. The inner side of the light-shielding film 18 corresponds to the display region E having the plurality of pixels P. Although not illustrated in FIG. 1, a light-shielding film defining the plurality of pixels P two-dimensionally is also provided in the display region E.

The wirings connected to the data line driving circuit 22 and the scan line driving circuits 24 are connected to a plurality of external connection terminals 61 aligned along the one side. In the following description, the direction along the one side is defined as an X direction and the direction along the other two sides that are orthogonal to the one side and oppose each other is defined as a Y direction.

As illustrated in FIG. 2, pixel electrodes 27 having light transmissivity, thin film transistors (TFTs, hereinafter, referred to as “TFTs 30”) as switching elements, signal wirings (not illustrated), and an alignment film 28 are provided on the surface of the first base member 10a at the liquid crystal layer 15 side. The pixel electrodes 27 and the TFTs 30 are provided for the respective pixels P. The alignment film 28 covers the above-mentioned components.

A light-shielding structure that prevents occurrence of a problem that light is incident on semiconductor layers of the TFTs 30 and switching operations thereof become unstable is employed. The element substrate 10 in the invention includes at least the pixel electrodes 27, the TFTs 30, and the alignment film 28.

The light-shielding layer 18, an insulating layer 33 film-formed so as to cover the light-shielding film 18, a counter electrode 31 provided so as to cover the insulating layer 33, and an alignment film 32 covering the counter electrode 31 are provided on the surface of the counter substrate 20 at the liquid crystal layer 15 side. The counter substrate 20 in the invention includes at least the insulating layer 33, the counter electrode 31, and the alignment film 32.

As illustrated in FIG. 1, the light-shielding film 18 is provided at a position surrounding the display region E and overlapping with the scanning line driving circuits 24 and the test circuit 25 two-dimensionally (simply illustrated in FIG. 1). The light-shielding film 18 blocks light that is incident on the peripheral circuits including these driving circuits from the counter substrate 20 side so as to prevent malfunction of the peripheral circuits due to the light. In addition, the light-shielding film 18 blocks light such that unnecessary stray light is not incident on the display region E so as to ensure high contrast on display on the display region E.

The insulating layer 33 is made of an inorganic material such as silicon oxide (SiO₂), for example, has light transmissivity, and is provided so as to cover the light-shielding film 18. As a method of forming the insulating layer 33, a film formation method by using a plasma chemical vapor deposition (CVD) technique is exemplified.

The counter electrode 31 is formed by a transparent conductive film such as ITO. The counter electrode 31 covers the insulating layer 33 and is electrically connected to the wirings at the element substrate 10 side by vertical conducting portions 26 provided in four corners of the counter substrate 20, as illustrated in FIG. 1.

The alignment film 28 covering the pixel electrodes 27 and the alignment film 32 covering the counter electrode 31 are selected based on optical design of the liquid crystal device 100. For example, an inorganic alignment film obtained by forming a film of an inorganic material such as silicon oxide (SiO₂) by a vapor deposition method and performing substantially vertical alignment processing on liquid crystal molecules having negative dielectric anisotropy is used for them.

The liquid crystal device 100 is of a transmission type, and employs optical design of the normally white mode or the normally black mode. In the normally white mode, the transmissivity of the respective pixels P when a voltage is not applied to the pixels P is larger than the transmissivity when the voltage is applied to the pixels P. In the normally black mode, the transmissivity of the respective pixels P when the voltage is not applied to the pixels P is smaller than the transmissivity when the voltage is applied to the pixels P. A polarization element is arranged to be used at each of the light incident side and the light output side in accordance with the optical design.

As illustrated in FIG. 3, the liquid crystal device 100 includes a plurality of scan lines 3a, a plurality of data lines 6a, and capacitor lines 3b as common potential wirings. The scan lines 3a and the data lines 6a are formed at least on the display region E so as to be insulated from and orthogonal to each other. The direction in which the scan lines 3a extend corresponds to the X direction. The direction in which the data lines 6a extend corresponds to the Y direction.

The scan lines 3a, the data lines 6a, the capacitor lines 3b, and the pixel electrodes 27, the TFTs 30, and the capacitor elements 16 configure the pixel circuits of the pixels P. The pixel electrodes 27, the TFTs 30, and the capacitor elements 16 are provided on regions partitioned by the above-mentioned signal lines.

The scan lines 3a are electrically connected to gates of the TFTs 30 and the data lines 6a are electrically connected to data line-side source-drain regions (source regions) of the TFTs 30. The pixel electrode 27 are electrically connected to pixel electrode-side source-drain regions (drain regions) of the TFTs 30.

The data lines 6a are connected to the data line driving circuit 22 (see FIG. 1) and supply image signals D1, D2, . . . , Dn that are supplied from the data line driving circuit 22 to the respective pixels P. The scan lines 3a are connected to the scanning line driving circuits 24 (see FIG. 1) and supply scan signals SC1, SC2, . . . , SCm that are supplied from the scanning line driving circuits 24 to the respective pixels P.

The image signals D1 to Dn that are supplied to the data lines 6a from the data line driving circuit 22 may be supplied in this order in a line sequential manner or may be supplied to groups each of which is configured of a plurality of data lines 6a adjacent to one another. The scanning line driving circuits 24 supply the scan signals SC1 to SCm to the scan lines 3a at predetermined timings.

The liquid crystal device 100 has the following configuration. That is, the image signals D1 to Dn that are supplied from the data lines 6a are written into the pixel electrodes 27 at predetermined timings when the TFTs 30 as the switching elements are made into ON states only for a constant period of time with the input of the scan signals SC1 to SCm. Then, the image signals D1 to Dn at predetermined levels, which have been written into the liquid crystal layer 15 through the pixel electrodes 27, are held between the pixel electrodes 27 and the counter electrode 31 arranged so as to oppose the pixel electrodes 27 through the liquid crystal layer 15 for a constant period of time.

In order to prevent the held image signals D1 to Dn from leaking, the capacitor elements 16 are connected in parallel with the liquid crystal capacitor formed between the pixel electrodes 27 and the counter electrode 31. The capacitor elements 16 are provided between the pixel electrode-side source-drain regions of the TFTs 30 and the capacitor lines 3b.

### Configuration of Pixels Configuring Liquid Crystal Device

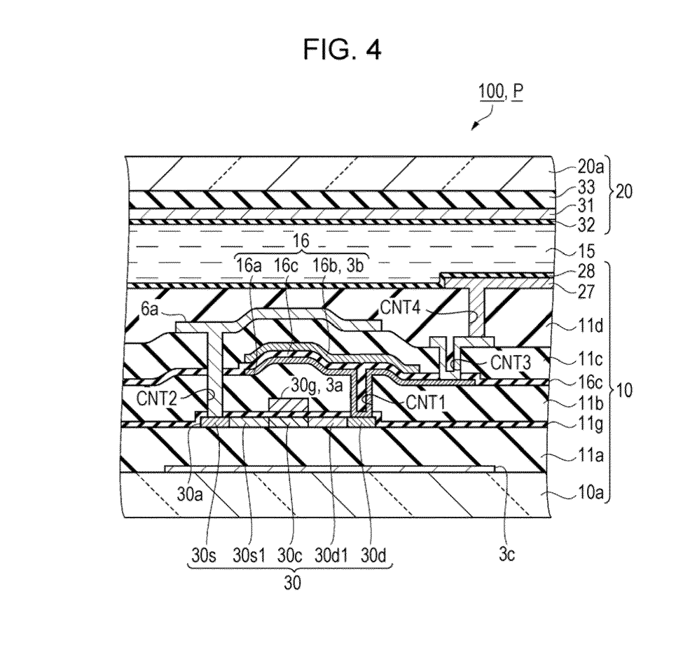

FIG. 4 is a schematic cross-sectional view mainly illustrating the configuration of the pixel of the liquid crystal device. Hereinafter, the configuration of the pixel of the liquid crystal device is described with reference to FIG. 4. FIG. 4 illustrates cross-sectional positional relation among the respective constituent components in scales that can be observed clearly.

As illustrated in FIG. 4, the liquid crystal device 100 includes the element substrate 10 and the counter substrate 20 arranged so as to oppose the element substrate 10. For example, the first base member 10a configuring the element substrate 10 is formed by the quartz substrate or the like, as described above.

As illustrated in FIG. 4, a lower light-shielding film 3c containing a material such as aluminum (Al), titanium (Ti), chromium (Cr), and tungsten (W), for example, is formed on the first base member 10a. The lower light-shielding film 3c is patterned in a grid form two-dimensionally to define opening regions of the respective pixels P. The lower light-shielding film 3c has conductivity and may function as a part of the scan lines 3a. A foundation insulating layer 11a is formed on the first base member 10a and the lower light-shielding film 3c. The foundation insulating layer 11a is formed by a silicon oxide film or the like.

The TFTs 30, the scan lines 3a, and the like are formed on the foundation insulating layer 11a. Each TFT 30 has a lightly doped drain (LDD) structure and includes a semiconductor layer 30a, a gate insulating layer 11g, and a gate electrode 30g. The semiconductor layer 30a is made of polysilicon (high-purity polycrystalline silicon) or the like. The gate insulating layer 11g is formed on the semiconductor layer 30a. The gate electrode 30g is formed on the gate insulating layer 11g and is formed by a polysilicon film or the like. The scan line 3a also functions as the gate electrode 30g.

N-type impurity ions such as phosphorus (P) ions, for example, are injected into the semiconductor layer 30a so as to form the N-type TFT 30. To be specific, the semiconductor layer 30a includes a channel region 30c, a data line-side LDD region 30s1, a data line-side source-drain region 30s, a pixel electrode-side LDD region 30d1, and a pixel electrode-side source-drain region 30d.

The channel region 30c is doped with P-type impurity ions such as boron (B) ions. Other regions (30s1, 30s, 30d1, 30d) are doped with N-type impurity ions such as phosphorus (P) ions. Thus, each TFT 30 is formed as the N-type TFT.

A first interlayer insulating layer 11b is formed on the gate electrodes 30g and the gate insulating layer 11g. The first interlayer insulating layer 11b is formed by a silicon oxide film or the like. The capacitor elements 16 are provided on the first interlayer insulating layer 11b. To be specific, the capacitor elements 16 are formed by arranging first capacitor electrodes 16a as pixel potential-side capacitor electrodes and a part of the capacitor lines 3b (second capacitor electrodes 16b) as fixed potential-side capacitor electrodes so as to oppose each other through a dielectric film 16c. The first capacitor electrodes 16a are electrically connected to the pixel electrode-side source-drain regions 30d of the TFTs 30 and the pixel electrodes 27.

The dielectric film 16c is formed by a silicon nitride film, for example. The second capacitor electrodes 16b (capacitor lines 3b) can be made of a single metal, alloy, metal silicide, polysilicide, or a laminated material thereof, containing at least one of metals having a high melting point, such as titanium (Ti), chromium (Cr), tungsten (W), tantalum (Ta), and molybdenum (Mo), for example. Alternatively, the second capacitor electrodes 16b can be also formed by an aluminum (Al) film.

The first capacitor electrodes 16a are formed by a conductive polysilicon film and function as the pixel potential-side capacitor electrodes of the capacitor elements 16. It should be noted that the first capacitor electrodes 16a may be formed by either a single layer or a multilayered film containing a metal or alloy in the same manner as the capacitor lines 3b. The first capacitor electrodes 16a have a function of relaying and connecting the pixel electrodes 27 and the pixel electrode-side source-drain regions 30d (drain regions) of the TFTs 30 through contact holes CNT1, CNT3, and CNT4 in addition to the function as the pixel potential-side capacitor electrodes.

The data lines 6a are formed on the capacitor elements 16 through a second interlayer insulating layer 11c. The data lines 6a are electrically connected to the data line-side source-drain regions 30s (source regions) of the semiconductor layers 30a through contact holes CNT2 opened on the gate insulating layer 11g, the first interlayer insulating layer 11b, the dielectric film 16c, and the second interlayer insulating layer 11c.

The pixel electrodes 27 are formed on an upper layer of the data lines 6a through a third interlayer insulating layer 11d. The third interlayer insulating layer 11d is made of silicon oxide or nitride, for example, and flattening processing for flattening projecting portions of the surface is performed on the third interlayer insulating layer 11d. The projecting portions of the surface are generated by covering the region on which the TFTs 30 are provided. As a method of the flattening processing, chemical mechanical polishing (CMP) processing, spin coat processing, or the like can be employed, for example. The contact holes CNT4 are formed on the third interlayer insulating layer 11d.

The pixel electrodes 27 are connected to the first capacitor electrodes 16a through the contact holes CNT4 and CNT3 so as to be electrically connected to the pixel electrode-side source-drain regions 30d (drain region) of the semiconductor layers 30a. The pixel electrodes 27 are formed by a transparent conductive film such as an ITO film, for example.

The alignment film 28 is provided on the pixel electrodes 27 and the third interlayer insulating layer 11d between the adjacent pixel electrodes 27. The alignment film 28 is obtained by performing oblique evaporation on an inorganic material such as silicon oxide (SiO₂). The liquid crystal layer 15 in which liquid crystal and the like are injected into a space surrounded by the sealing member 14 (see FIG. 1 and FIG. 2) is provided on the alignment film 28.

On the other hand, for example, the insulating layer 33 formed by a phosphor-doped silicon oxide film (PSG film) or the like is provided on the second base member 20a (at the liquid crystal layer 15 side). The counter electrode 31 is provided on the whole surface of the insulating layer 33. The alignment film 32 obtained by performing oblique evaporation on an inorganic material such as silicon oxide (SiO₂) is provided on the counter electrode 31. The counter electrode 31 is formed by a transparent conductive film such as an ITO film, for example, in the same manner as the above-mentioned pixel electrodes 27.

The liquid crystal layer 15 takes a predetermined alignment state by the alignment films 28 and 32 in a state where no electric field is generated between the pixel electrodes 27 and the counter electrode 31. The sealing member 14 is an adhesive made of a photo-curable resin or a thermosetting resin, for example, for bonding the element substrate 10 and the counter substrate 20. A spacer such as glass fiber or glass beads for setting a distance between the element substrate 10 and the counter substrate 20 to a predetermined value is mixed into the sealing member 14.

### Configuration of Sealing Member and Protruding Members

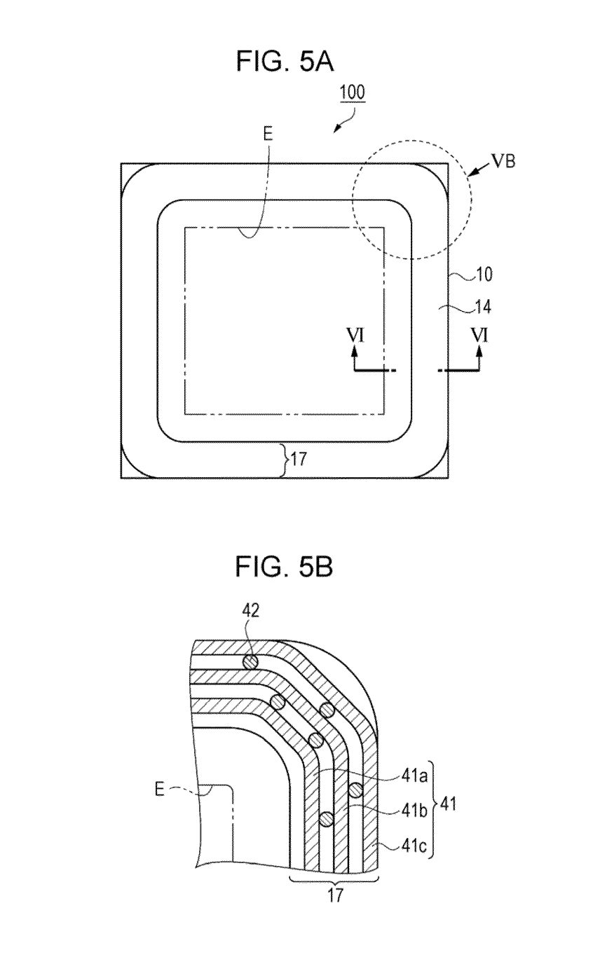

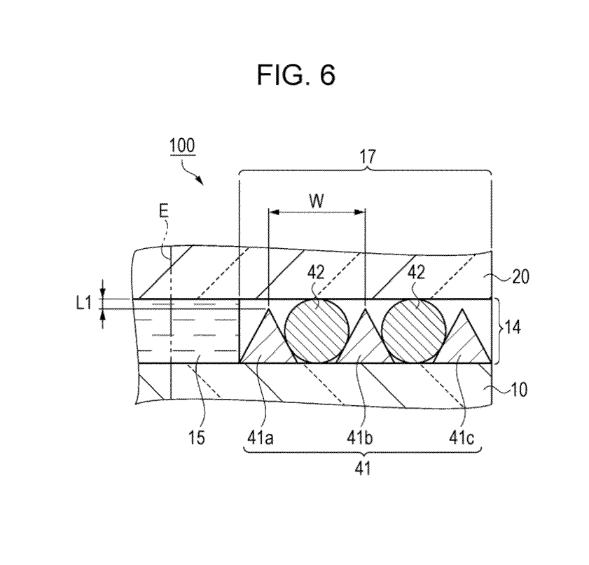

FIGS. 5A and 5B are schematic views mainly illustrating the configurations of the sealing member and protruding members of the liquid crystal device. FIG. 5A is a schematic plan view. FIG. 5B is an enlarged plan view illustrating a VB portion of the liquid crystal device in FIG. 5A in an enlarged manner. FIG. 6 is a schematic cross-sectional view of the liquid crystal device as illustrated in FIG. 5A cut along a line VI-VI. Hereinafter, the configurations of the sealing member and the protruding members are described with reference to FIGS. 5A and 5B and FIG. 6.

As illustrated in FIGS. 5A and 5B, the sealing member 14 is provided around the display region E on the element substrate 10. As illustrated in FIG. 6, protruding members 41 are provided on a seal formation region 17 on which the sealing member 14 is provided so as to surround the display region E. The protruding members 41 are members for preventing permeation of water from the outside through the sealing member 14.

As the protruding members 41, a first protruding member 41a, a second protruding member 41b, and a third protruding member 41c are arranged at a predetermined interval W in this order from the display region E side, for example. As illustrated in FIG. 5B, spacers 42 for keeping a cell gap of a predetermined dimension are arranged between the first protruding member 41a and the second protruding member 41b and between the second protruding member 41b and the third protruding member 41c.

As illustrated in FIG. 6, cross sections of the first protruding member 41a to the third protruding member 41c are substantially triangular shapes. With this, the spacers 42 can be arranged between both the protruding members 41 without being placed on the protruding members 41 when the spacers 42 make contact with the protruding members 41.

As illustrated in FIG. 6, the first protruding member 41a to the third protruding member 41c are formed to be lower than the spacers 42. This enables the cell gap between the element substrate 10 and the counter substrate 20 to be determined based on the height of the spacers 42.

It is sufficient that each of the protruding members 41a to 41c is lower than the spacers 42, and a space L1 between the counter substrate 20 and each of the protruding members 41a to 41c is preferably small. The diameter of each spacer 42 is approximately 2.5 μm, for example. Thus, when the protruding members 41 are provided and the space L1 between the protruding members 41 and the counter substrate 20 is small, permeation of water into the liquid crystal layer 15 from the outside through the sealing member 14 can be suppressed.

### Liquid Crystal Device Manufacturing Method

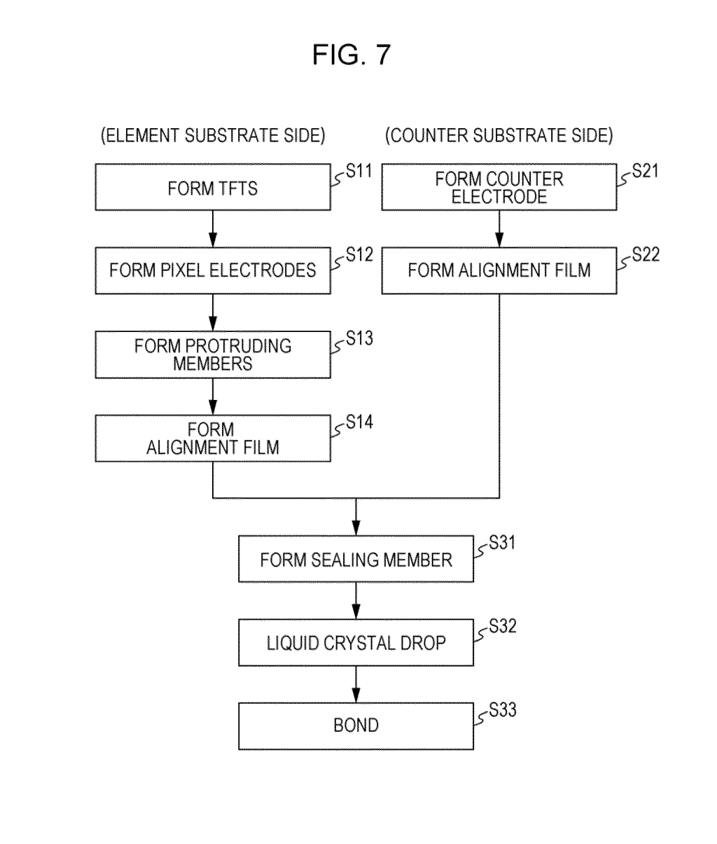

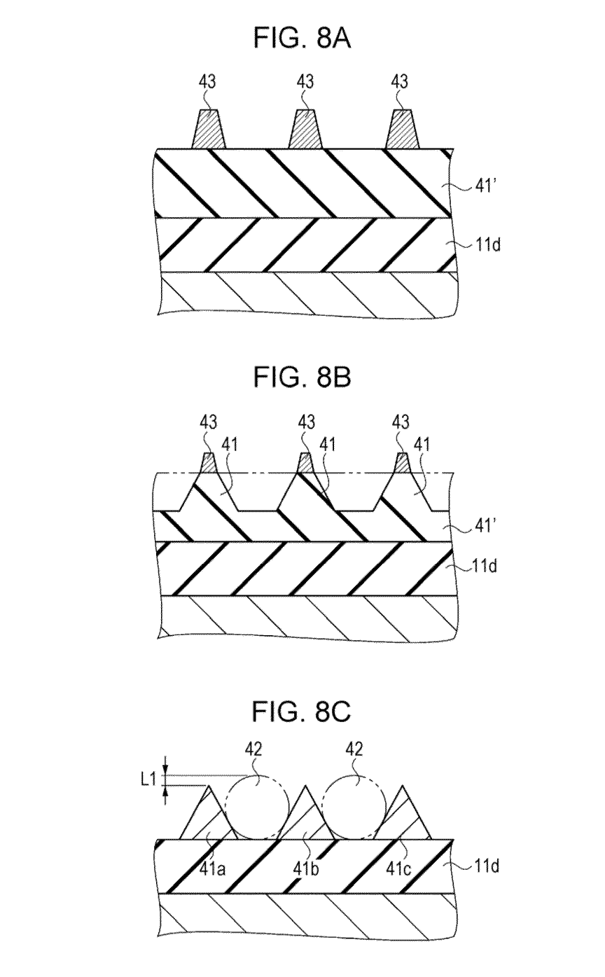

FIG. 7 is a flowchart illustrating a liquid crystal device manufacturing method in the order of procedures. FIGS. 8A to 8C are schematic cross-sectional views illustrating a method of manufacturing the protruding members in the liquid crystal device manufacturing method. Hereinafter, the liquid crystal device manufacturing method is described with reference to FIG. 7 and FIGS. 8A to 8C.

First, a method of manufacturing the element substrate 10 side is described. The TFTs 30 are formed on the first base member 10a formed by the quartz substrate or the like at step S11. To be specific, the lower light-shielding film 3c (scan lines) made of aluminum or the like is formed on the first base member 10a. Thereafter, the foundation insulating layer 11a formed by a silicon oxide film or the like is deposited by a well-known film formation technique.

Then, the TFTs 30 are formed on the foundation insulating layer 11a. To be specific, the TFTs 30 are formed by using the well-known film formation technique, a photolithography technique, and an etching technique.

At step S12, the pixel electrodes 27 are formed. As the manufacturing method, the pixel electrodes 27 are formed by using the well-known film formation technique, the photolithography technique, and the etching technique as described above.

The protruding members 41 are formed at step S13. To be specific, first, a silicon oxide film (SiO₂) 41′ as an inorganic material, for example, is vapor-deposited on the seal formation region 17 on the element substrate 10. Thereafter, as illustrated in FIG. 8A, resist patterns 43 are formed on the silicon oxide film 41′ by using the photolithography technique. The resist patterns 43 are formed to have substantially triangular shapes by using a halftone mask for adjusting an amount of exposed light, or the like.

In a process as illustrated in FIG. 8B, etching processing is performed by using the resist patterns 43 as masks so as to perform etching (etch-back) on the resist patterns 43 and the silicon oxide film 41′. This allows starting of formation of the protruding members 41 to which the shapes of the resist patterns 43 are reflected.

In a process as illustrated in FIG. 8C, the etching processing is made to further proceed. The etching processing is performed until the silicon oxide film 41′ is formed into the substantially triangular shapes. With this, the protruding members 41a and 41c having the substantially triangular shapes, which are lower than the spacers 42, are completed.

Next, the alignment film 28 is formed at step S14 with reference to FIG. 7, again. To be specific, the alignment film 28 is formed so as to cover the pixel electrodes 27 and the protruding members 41. As a method of manufacturing the alignment film 28, the oblique evaporation method of performing oblique evaporation on an inorganic material such as silicon oxide (SiO₂) is employed, for example. With this, the element substrate 10 side is completed.

Then, a method of manufacturing the counter substrate 20 side is described. First, at step S21, the counter electrode 31 is formed on the second base member 20a made of a material having light transmissivity, such as a glass substrate, by using the well-known film formation technique, the photolithography technique, and the etching technique as described above.

The alignment film 32 is formed on the counter electrode 31 at step S22. A method of manufacturing the alignment film 32 is the same as the method of manufacturing the alignment film 28 and the alignment film 32 is formed by using the oblique evaporation method, for example. With this, the counter substrate 20 side is completed. Next, a method of bonding the element substrate 10 and the counter substrate 20 is described.

At step S31, the sealing member 14 is applied onto the element substrate 10. To be specific, the sealing member 14 is applied onto a peripheral edge of the display region E on the element substrate 10 (so as to surround the display region E) while changing a relative positional relation between the element substrate 10 and a dispenser (a discharging device may be available).

For example, the ultraviolet-curable epoxy resin is employed as the sealing member 14. The sealing member 14 is not limited to be formed by the photo-curable resin such as the ultraviolet ray-curable resin and may be formed by the thermosetting resin or the like. For example, the sealing member 14 contains a gap member such as the spacers 42 for setting a space (gap or cell gap) between the element substrate 10 and the counter substrate 20 to the predetermined value.

Then, the spacers 42 contained in the sealing member 14 are arranged between the protruding member 41 and the protruding member 41. Alternatively, when the counter substrate 20 is bonded later, the spacers 42 are arranged between the protruding member 41 and the protruding member 41.

At step S32, liquid crystal is made to drop into (supplied to) a region surrounded by the sealing member 14. To be specific, the liquid crystal is made to drop into the region surrounded by the sealing member 14 (one drop fill (ODF) method). As a dropping method, an ink jet head or the like can be used, for example. Further, the liquid crystal is desirably made to drop into the center portion of the region (display region E) surrounded by the sealing member 14.

The element substrate 10 and the counter substrate 20 are bonded to each other at step S33. To be specific, the element substrate 10 and the counter substrate 20 are bonded to each other with the sealing member 14 applied to the element substrate 10. To be more specific, they are bonded while ensuring positional accuracy in the longitudinal direction and the lateral direction of the substrates 10 and 20 two-dimensionally. With this, the liquid crystal device 100 is completed.

### Configuration of Electronic Apparatus

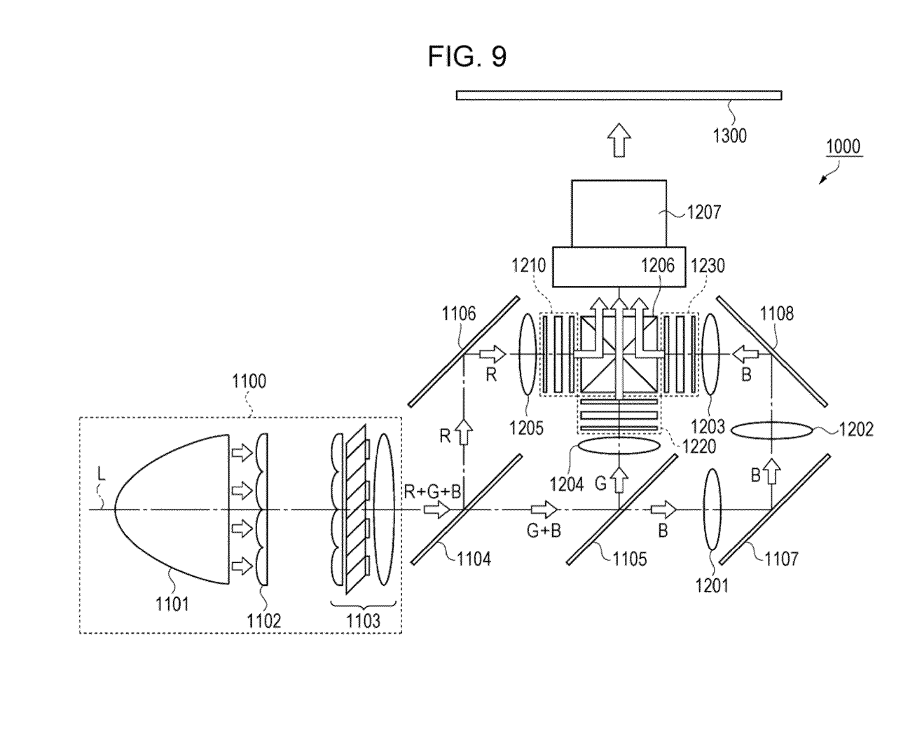

Next, a projection-type display apparatus as an electronic apparatus according to the embodiment is described with reference to FIG. 9. FIG. 9 is a schematic view illustrating the configuration of the projection-type display apparatus including the above-mentioned liquid crystal device.

As illustrated in FIG. 9, a projection-type display apparatus 1000 in the embodiment includes a polarized illumination device 1100, two dichroic mirrors 1104 and 1105 as light separation elements, three reflecting mirrors 1106, 1107, and 1108, five relay lenses 1201, 1202, 1203, 1204, and 1205, three transmission-type liquid crystal light valves 1210, 1220, and 1230 as light modulation units, a cross dichroic prism 1206 as a light combination element, and a projection lens 1207. The polarized illumination device 1100 is arranged along a system optical axis L.

The polarized illumination device 1100 is configured by a lamp unit 1101 as a light source, an integrator lens 1102, and a polarization converting element 1103 schematically. The lamp unit 1101 is formed by a white light source such as an ultrahigh pressure mercury lamp or a halogen lamp, for example.

The dichroic mirror 1104 reflects red light (R) and transmits green light (G) and blue light (B) among polarized light beams emitted from the polarized illumination device 1100. The other dichroic mirror 1105 reflects the green light (G) that has passed through the dichroic mirror 1104 and transmits the blue light (B).

The red light (R) reflected by the dichroic mirror 1104 is reflected by the reflecting mirror 1106, and then, enters the liquid crystal light valve 1210 through the relay lens 1205. The green light (G) reflected by the dichroic mirror 1105 enters the liquid crystal light valve 1220 through the relay lens 1204. The blue light (B) that has passed through the dichroic mirror 1105 enters the liquid crystal light valve 1230 through a light guide system configured by the three relay lens 1201, 1202, and 1203 and the two reflecting mirrors 1107 and 1108.

The liquid crystal light valves 1210, 1220, and 1230 are arranged so as to oppose incident surfaces of the cross dichroic prism 1206 for respective color light components. The color light components that enter the liquid crystal light valves 1210, 1220, and 1230 are modulated based on video image information (video image signal) and are emitted to the cross dichroic prism 1206.

The prism is configured by bonding four rectangular prisms. A dielectric multilayer film that reflects red light and a dielectric multilayer film that reflects blue light are formed on the inner surfaces thereof in a cross shape. The light components of the three colors are then synthesized by these dielectric multilayer films to form light representing a color image. The synthesized light is projected onto a screen 1300 by the projection lens 1207 as a projection optical system, so that the image is displayed in an enlarged manner.

The above-mentioned liquid crystal device 100 is applied to the liquid crystal light valve 1210. The liquid crystal device 100 is arranged between a pair of polarization elements arranged at the incident side and the output side of the color light in a crossed Nichol system with a space therebetween. The other liquid crystal light valves 1220 and 1230 are arranged in the same manner.

The projection-type display apparatus 1000 includes the liquid crystal light valves 1210, 1220, and 1230, thereby obtaining high reliability.

As the electronic apparatus on which the liquid crystal device 100 is mounted, various electronic apparatuses including a head up display, a smart phone, an electrical view finder (EVF), a mobile mini projector, a mobile phone, a mobile computer, a digital camera, a digital video camera, a display, an in-vehicle apparatus, an audio apparatus, an exposure apparatus, and an illumination apparatus in addition to the projection-type display apparatus 1000 can be employed.

As described in detail, with the liquid crystal device 100, the method of manufacturing the liquid crystal device 100, and the electronic apparatus in the embodiment, the following effects are obtained.

1. With the liquid crystal device 100 and the method of manufacturing the liquid crystal device 100 in the embodiment, the first protruding member 41a, the second protruding member 41b, and the third protruding member 41c that are lower than the spacers 42 are arranged in the region covered by the sealing member 14. Therefore, the spacers 42 can define the cell gap and a space between the counter substrate 20 and each of the protruding members 41a to 41c can be made small. In other words, the thickness of the sealing member 14 on each of the protruding members 41a to 41c can be made small. Thus, each protruding member made of an inorganic material is provided in the sealing member 14, so that water is difficult to pass through the sealing member from the outside, thereby improving moistureproof and suppressing permeation of water into the liquid crystal layer 15. This can suppress lowering of display quality.

2. With the liquid crystal device 100 and the method of manufacturing the liquid crystal device 100 in the embodiment, the cross-sectional shapes of the protruding members 41 are substantially triangles. Therefore, the spacers 42 can be arranged between both the protruding members 41 without being placed on the apexes of the substantially triangular shapes even when the spacers 42 are arranged on the formation region of the sealing member 14.

3. With the electronic apparatus in the embodiment, the electronic apparatus includes the above-mentioned liquid crystal device 100. Therefore, an electronic apparatus that can suppress lowering of display quality can be provided.

The aspects of the invention are not limited to the above-mentioned embodiments and can be varied appropriately in a range without departing from the scope or the spirit of the invention, which can be understood from the appended scope of the invention and the whole specification. The variations are encompassed in the technical range of the aspects of the invention. Further, the aspects of the invention can be also executed in the following modes.

### First Variation

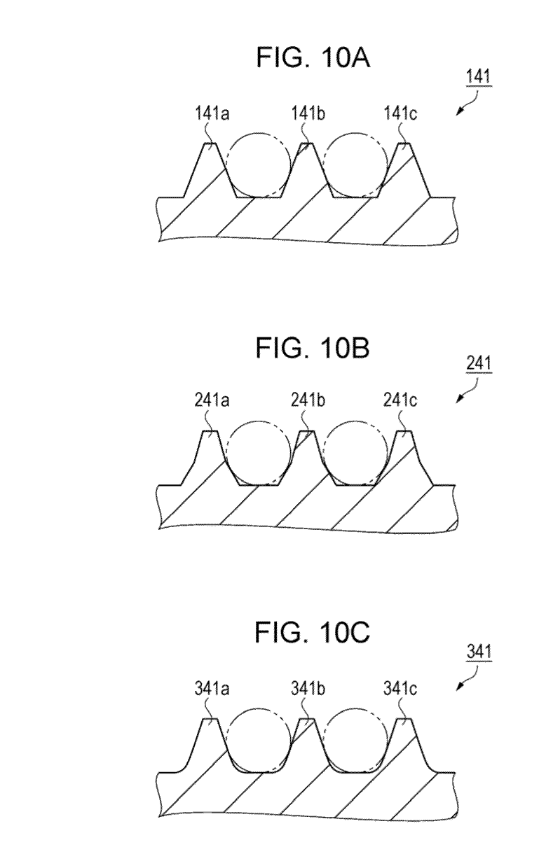

The shapes of the protruding members 41 are not limited to the above-mentioned shapes and may be shapes as illustrated in FIGS. 10A to 10C. FIGS. 10A to 10C are schematic cross-sectional views illustrating the configuration of the protruding members according to the variation. Protruding members 141 (141a, 141b, 141c) in FIG. 10A have flat portions on upper portions of the substantial triangles. The flat portions on the upper portions preferably have such areas that the spacers 42 are not placed thereon. Furthermore, they preferably have such areas that the upper portions of the protruding members 141 are not damaged due to contact with the spacers 42.

Protruding members 241 (241a, 241b, 241c) as illustrated in FIG. 10B are provided with steps on side walls and are formed to be thicker toward the lower side. Protruding members 341 (341a, 341b, 341c) as illustrated in FIG. 10C have side walls formed into a substantially arc form. Further, bottoms of grooves are not limited to be flat and may be formed into an arc form. The protruding members are not limited to have these shapes. It is sufficient that the protruding members have shapes that the spacers 42 are arranged between both the protruding members, the cell gap can be kept by the spacers 42, the protruding members are easy to be formed, and the strength of the protruding members can be kept.

### Second Variation

The number of protruding members 41 that are provided is not limited to three as described above. It is sufficient that the protruding members 41 make water difficult to pass therethrough. For example, one, two, or equal to or more than three protruding members 41 may be provided.

### Third Variation

Although the transmission-type liquid crystal device 100 has been described as an example above, the invention may be applied to a reflection-type liquid crystal device.

The entire disclosure of Japanese Patent Application No. 2013-107725, filed May 22, 2013 is expressly incorporated by reference herein.

What is claimed is:

1. A liquid crystal device comprising:
a first substrate;
a first protruding member that is arranged around a display region above a first surface of the first substrate;
a second protruding member that is arranged around the first protruding member;
a spacer that is arranged between the first protruding member and the second protruding member, and the spacer is higher than the first protruding member and the second protruding member respectively;
a sealing member that is arranged so as to cover the first protruding member, the second protruding member, and the spacer; and
a second substrate that is bonded to the first substrate so as to hold a liquid crystal layer with the sealing member between the second substrate and the first substrate.

2. The liquid crystal device according to claim 1,
wherein a third protruding member that is arranged around the second protruding member, and the third protruding member is lower than the spacer.

3. The liquid crystal device according to claim 2,
wherein at least one of the first protruding member, the second protruding member, and the third protruding member having a substantially triangle shape in a cross sectional view when viewed from a direction parallel to the first surface.

4. The liquid crystal device according to claim 1,
wherein the spacer is arranged so as to make contact with a surface between the first protruding member and the second protruding member.

5. An electronic apparatus comprising the liquid crystal device according to claim 1.

6. An electronic apparatus comprising the liquid crystal device according to claim 2.

7. An electronic apparatus comprising the liquid crystal device according to claim 3.

8. An electronic apparatus comprising the liquid crystal device according to claim 4.
